(19) United States
(12) Patent Application Publication
(10) Pub. No.: US 2026/0283391 A1
(43) Pub. Date: Sep. 24, 2026

(54) STEAM OVEN WITH SEARING MEANS

(71) Applicant: Raja Singh Tuli, Montreal (CA)

(72) Inventor: Raja Singh Tuli, Montreal (CA)

(21) Appl. No.: 19/700,460

(22) Filed: Jun. 8, 2026

Related U.S. Application Data
(62) Division of application No. 18/736,125, filed on Jun. 6, 2024.

(51) Int. Cl. A47J 27/04; A23L 5/10; A47J 27/00; G06T 7/60; G06V 20/50; G06V 20/68

(52) U.S. Cl. CPC A47J 27/04; A23L 5/13; A23L 5/15; A23L 5/17; A47J 27/004; G06T 7/60; G06V 20/50; G06V 20/68; A47J 2027/043; A47J 2202/00

(57) ABSTRACT

The present invention provides an apparatus and a method for cooking the foodstuff in a pressurized steam oven with the foodstuff being steam cooked in the first stage and seared in the next stage. The method automatically identifies the time of the first stage (slow) cooking and the time of the second stage (fast) cooking based on the type, size, temperature, and 3D image of the foodstuff. The slow cook is stopped before the foodstuff reaches the critical temperature by an amount determined by various parameters and next, the fast cook of searing is started. The slow cook method can be a pressurized steam cooking method. The method automatically reduces the time of the slow cooking so that the internal temperature of the food does not prematurely reach the critical temperature. The method helps in avoiding overcooking the foodstuff during the searing stage.

### CROSS-REFERENCE TO RELATED APPLICATIONS

This application is a divisional application of and incorporates by reference in its entirety U.S. application Ser. No. 18/736,125, filed on Jun. 6, 2024 and entitled STEAM OVEN WITH SEARING MEANS”, which claims priority to U.S. provisional patent application No. 63/525,007, entitled “STEAM OVEN WITH SEARING MEANS,” filed on Jul. 5, 2023. The content of this U.S. provisional patent application is hereby incorporated by reference in its entirety for all purposes.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure generally relates to the field of cooking foodstuffs such as meats and vegetables, in a faster, more efficient manner. More particularly, the invention relates to a method and apparatus for cooking the foodstuff in a pressurized steam oven with the foodstuff being steam cooked in a first stage and seared in a second stage. The invention also relates to the technical field of cooking appliances, in particular to a steam oven control method and device, cooking equipment, steam cooking, and searing all-in-one machine.

### Description of Related Art

Intelligent household appliances, such as steaming and baking ovens, have made life more convenient by providing a range of facilities. However, these appliances often have different settings for different brands and models, making it difficult for users without experience to correctly set the heating mode, temperature, and time for a particular food material. Even those with some experience may find it challenging to adjust the settings for different types of food. To produce delicious meals, it is important for users to understand the various heating modes, temperatures, and times for their specific oven and the food they are cooking. However, this can be complicated, particularly for those with limited cooking experience. If the parameters are set incorrectly, it can result in undercooked or overcooked food that must be discarded, leading to wasted food and energy. Improperly cooked food can also be a safety hazard, as undercooked food may contain harmful bacteria while overcooked food may be burnt and potentially cause injury. It is important for users to carefully set the appropriate parameters and monitor the cooking process to ensure that their food is cooked safely and properly.

While some ovens claim to determine if the food is cooked properly, the determination is purely based on the outer surface of the food. This can lead to inaccurate judgment, resulting in a poor user experience. For example, the surface of the food may appear to be cooked, but the inner part may still be raw. This can be a safety hazard, as undercooked food may contain harmful bacteria, and it can also be frustrating for the user who may have to discard the food and start over. To ensure that food is cooked properly, it is important for the oven to be able to identify the food material, and accurately assess the internal temperature of the food while cooking, not just the surface.

There are some methods that use image recognition technology to identify the type of food material and automatically cook it. However, these methods are limited in that they only identify the food material and initiate cooking, resulting in a poor automatic cooking experience for the user. To improve the automatic cooking experience, it would be helpful for the oven to be able to not only identify the type of food, but also adjust the cooking parameters based on the specific characteristics of the food, such as its size, shape, and desired level of doneness. This would allow for more precise and personalized cooking, resulting in a better overall user experience.

In the past, methods and devices have used compressed air (both preheated and not) to achieve browning and surface texture on cooked meat and have tried to control the relative humidity within an oven or pressure vessel. However, these known pressure cooking processes that use high-pressure steam tend to produce meat that looks and tastes boiled rather than roasted. This can be undesirable for those who prefer the taste and appearance of roasted meat. To achieve a roasted flavor and texture, it may be necessary to use additional cooking methods or techniques once high-pressure steam cooking step is complete.

Another problem with using high-pressure steam for cooking foodstuff is that it can lead to overcooking easily, particularly for thin cuts of meat like fish and chicken. In a restaurant setting, it is possible to sear the meat quickly using a very hot oven, which conserves energy and reduces cooking time. However, this is not always possible at home, where cuts of meat may be thinner and more delicate. As a result, it can be difficult to achieve the desired balance of juicy and crisp when cooking meat at home. To achieve a perfectly cooked piece of meat that is juicy on the inside and crisp on the outside, it may be necessary to control the time of the cooking steps better suited to the type and thickness of the foodstuff being cooked.

There is accordingly a need for an improved cooking apparatus and cooking process by providing more precise and evenly distributed heat, as well as better control over the cooking environment.

It is therefore an object of the present invention to provide a cooking apparatus for cooking foodstuffs such as meats and vegetables, in a faster, more efficient manner by producing a mixture of compressed air and superheated steam. Further, the invention relates to a method and apparatus for cooking the foodstuff in a pressurized steam oven cavity with the foodstuff being steam cooked in a first stage and seared in a second stage. The invention can improve the cooking process by providing more precise and evenly distributed heat, as well as better control over the cooking environment. It may also be more energy efficient and easier to use compared to traditional cooking methods.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to cooking foodstuffs such as meats and vegetables, in a faster, more efficient manner. More particularly, the invention relates to a method and apparatus for cooking the foodstuff in a pressurized steam oven with the foodstuff being steam cooked in the first stage and seared in the next stage. The purpose of the present invention is to provide a faster and more efficient method of cooking food items while maintaining high product yield. Additionally, the invention can help in cooking and browning food items evenly in a single cycle.

In a preferred embodiment of the present invention, an apparatus and a method for cooking the foodstuff are disclosed. The foodstuff is steam cooked in the first stage and seared in the next stage. In another embodiment of the invention, the method automatically identifies the time of the first stage (slow) cooking and the time of the second stage (fast) cooking based on the type, size, and internal temperature, the foodstuff. The slow cook is stopped before the foodstuff reaches to critical temperature by an amount determined by various parameters and next, the fast cook stage of searing is started. The slow cook method can be a pressurized steam cooking method. The method automatically reduces the time of the slow cooking so that the internal temperature of the food does not prematurely reach the critical temperature. The method so helps in avoiding overcooking the foodstuff during the searing stage.

In an alternate embodiment of the invention, a camera inside the cooking apparatus can identify the foodstuff like beef, chicken, fish etc. placed inside the cooking chamber. The cooking apparatus can download the properties of the foodstuff from a database available at the computing device, user mobile device etc. Based on the properties of the foodstuff, the cooking apparatus determines the first portion of the time of cook and reduce that time such that when the sear happens in the next stage of cooking, the critical temperature is achieved but not exceeded and foodstuff is not overcooked.

In another embodiment of the invention, a thermometer inside the cooking chamber of the cooking apparatus continuously measures the internal temperature of the foodstuff. A rate of change of the internal temperature of the foodstuff can be calculated from the reading received from the thermometer. Based on the rate of change of the internal temperature of the foodstuff during the first cook period, the method can estimate an updated time for cooking the foodstuff in the first stage. The method can further predict the amount of time to be reduced for cooking the foodstuff in the first stage based on the rate of increase in the internal temperature of the foodstuff while cooking. In some embodiments, the method can reduce other parameters such as temperature, pressure or humidity etc. during the first cook period based on the rate of change of the internal temperature of the foodstuff. In another embodiment, other parameters such as, but not limited to, the initial temperature of the foodstuff, the current cooking temperature of the cooking apparatus and cooking pressure inside the cooking chamber of the cooking apparatus can also be used to predict the amount of time to be reduced for cooking the foodstuff in the first stage. Furthermore, the method can reduce the first portion of cooking time such that when the sear happens in the next stage of cooking, the critical temperature is achieved but not exceeded and the foodstuff is not overcooked.

In another embodiment of the invention, the cooking apparatus may comprise controlled heating elements and reflectors for efficient and consistent cooking. The heating elements inside the cooking apparatus are controlled by a computing device using an algorithm to alter or control the power provided to the heating elements. The heating elements can be quartz-halogen tungsten lamps or quartz-arc lamps producing light energy that includes energy in the visible and near visible light spectrum. The reflectors can be placed spaced apart from each of the heating elements or can be in the form of a coating on the ceiling of the cooking chamber. In some embodiments, the reflectors may be a standalone structure. The ceiling of the cooking chamber may also comprise a camera to capture the image of the foodstuff while cooking.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1a is a perspective front view of an example cooking apparatus in accordance with the subject disclosure.

FIG. 1b is a perspective side view of an example cooking apparatus in accordance with the subject disclosure.

FIG. 1c is a perspective side view of an example cooking apparatus in accordance with the subject disclosure.

FIG. 2 illustrates an example networked system of a cooking apparatus according to some embodiments of the invention.

FIG. 3 is a flow diagram illustrating the operation of the cooking apparatus in accordance with the various embodiments.

### DETAILED DESCRIPTION

The subject disclosure is directed to cooking foodstuffs such as meats and vegetables, in a faster, more efficient manner. More particularly, the invention relates to a method and apparatus for cooking the foodstuff in a pressurized steam oven with the foodstuff being steam cooked in the first stage and seared in the next stage.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, the foodstuff comprises foods items such as meat (e.g., bacon, pork chops, sausage, hamburger patties), poultry (e.g., whole turkey, chicken breasts or wings), seafood, vegetables (e.g., French fries, peppers), convenience or snack foods (e.g., burritos), pizza, breads, cookies, and pastries. It should be understood to one having ordinary skill in the art that foodstuff can comprise any variations of the above-mentioned food items marinated or lathered in oil or other substances.

Reverse searing is a two-step cooking technique that involves cooking a foodstuff slowly at a low temperature in the first step, and then searing it at a high temperature for a short period of time at the end of the cooking process in the second step. The result is a piece of foodstuff that is evenly cooked throughout and has a delicious, caramelized sear on the outside. However, the problem with the conventional reverse sear method of cooking foodstuff is that a user needs to take out the food from the oven and check the food item with a thermometer to measure the internal temperature while it is being slowly cooked at the first step. It is not easy for a person cooking the food to understand exactly when to stop the slow cook and start searing the food so that it is not overcooked. The foodstuff may not develop a proper sear or crust if the initial low temperature cooking is not done evenly or accurately. Foodstuff may be overcooked if the internal temperature reaches the critical temperature before foodstuff goes into the fast cooking or searing stage. Additionally, convection based methods heat the foodstuff from outside using high temperatures until the foodstuff is cooked from the inside. This may cause the juices in the foodstuff to evaporate and the foodstuff to become dry. So, it is important to monitor the cooking process closely and to adjust the temperature and cooking time as needed to ensure that the foodstuff is cooked to the desired level of doneness, i.e. juicy on the inside and crispy on the outside.

In some embodiments of the invention, the first cooking method can be any of the suitable methods but not limited to pressure cooking, roasting, baking, or sous vide. In a preferred embodiment, the first step cooking can be pressure steam cooking. Steam cooking and/or pressurized steam cooking can reduce the evaporation of juices from the foodstuff and also allow fast cooking at a lower temperatures due to higher conductivity of the steam. In some embodiments of the invention, the next step of reverse searing process can be any of the suitable methods but not limited to pan searing, grill searing, broiler searing or convection for cooking (searing) the foodstuff at very high temperature and to create a caramelized crust on the outside. In a preferred embodiment of the present invention, the second cooking method can use infra-red heating elements, more particularly, tungsten halogen, to sear the foodstuff. In another embodiment, the second cooking method may use a laser or infrared heating element to sear the foodstuff. It is important to understand that the searing should be performed for a lesser amount of time to avoid overcooking the food.

In some embodiments of the invention, more than two stages and more than two cooking methods can be used for cooking the foodstuff in the oven. It should also be understood that the multiple cooking steps can be performed in any suitable order without deviating from the scope of the proposed invention. In some embodiments of the invention, the first cooking method can be searing of the foodstuff and the second cooking method can be slow steam cooking of the foodstuff.

The critical temperature for a food item refers to the temperature at which the food is considered to be cooked or safe to eat. The critical temperature for a food item depends on the type of food and the desired level of doneness. For example, the critical temperature for meat, such as chicken or beef, is typically around 165 degrees Fahrenheit (74 degrees Celsius). At this temperature, the meat is considered to be fully cooked and safe to eat. The critical temperature for other types of food, such as vegetables, grains, and fish, may be different.

In a preferred embodiment of the invention, the method automatically identifies the time of the first step slow cooking and the time of the second stage fast cooking based on one or more of the type, size, and temperature as determined by various sensors. The slow cook is stopped before the foodstuff reaches the critical temperature by an amount determined by various parameters. Next, the fast cook of searing is started. In preferred embodiments of the invention, the slow cook method can be a pressurized steam cooking method. In alternate embodiments, any suitable methods mentioned supra can be used for slow cooking step. In a preferred embodiment of the invention, the method automatically reduces the time of the slow cooking so that the internal temperature of the food does not prematurely reach the critical temperature. In this way, the method avoids overcooking the food during the fast cooking searing step.

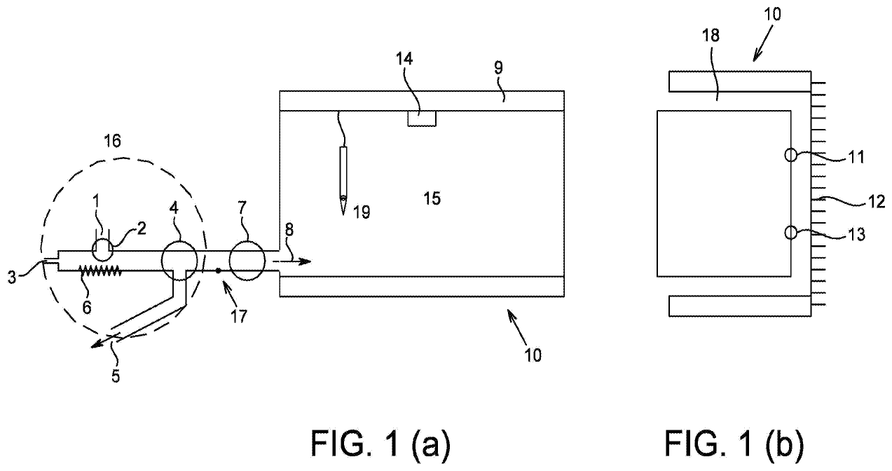

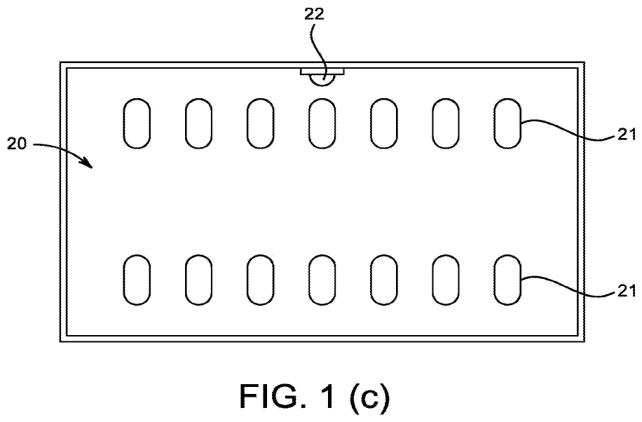

In FIG. 1a there is disclosed a cooking apparatus 10 made in accordance with the present invention. The cooking apparatus 10 comprises a chamber 15 to place the foodstuff to be cooked. According to an embodiment of the invention, pressurized steam or hot air can be injected into the cooking apparatus 10 and the pressure inside the chamber is regulated through an injector means 16. The injector means 16 includes a heating element 6, a water intake means 3 to intake a small amount of water, an air intake pipe 1 to intake air which is controlled by a computer-controlled valve 2, a computer-controlled mixer valve 4, and an inlet 5 for outside air. In a preferred embodiment of the invention, steam is generated outside of the chamber 15 and pumped inside the chamber 15 allowing to inject the steam at different temperatures based on requirements. Even very low temperature steam like moist air can be injected into the chamber.

In the preferred embodiment of the invention, water coming through the water inlet 3 falls on the heating element 6 in a small chamber and generates steam. The steam is then mixed with outside air provided through the air inlet 1 monitored by the computer-controlled valve 2. The valve 2 intelligently decides the mixing ratio of steam and outside air to create an appropriate amount of humidity inside the cooking chamber 15 through a humidity control algorithm. The valve 2 can also control the temperature of the steam and air mix by regulating the inlet air through the air inlet means 1. A temperature and humidity sensor 17 regularly measures the temperature and humidity of the steam and provides the readings to the valve 2. In this way, the valve 2 regulates and helps in generating the steam and air mix with an appropriate temperature and humidity. The generated steam is injected into the cooking chamber through an inlet 8 by a pump 7. It should be understood that in some embodiments of the invention, the cooking chamber 15 can comprise a pressure sensor to monitor the pressure inside the chamber and a humidity sensor to monitor the humidity inside the chamber. The pump 7 can pump the steam at specific pressure and regulate the pressure inside the chamber 15 based on feedback provided by a pressure sensor disposed inside the chamber 15 to measure the pressure.

FIG. 1b shows another perspective view of the cooking apparatus 10. When there is too much pressure inside the chamber 15, a computer-controlled valve 13 releases the steam and regulates the pressure inside the chamber. In a preferred embodiment of the invention, the valve 13 is provided at the back of the cooking apparatus 10 so that in the event of steam release due to the high pressure inside the chamber or due to any mechanical failure of the valve, the user does not get hurt. When the food stuff is being cooked inside the cooking chamber, it increases the humidity inside the cooking chamber by releasing moisture content into the chamber. In a preferred embodiment of the invention, the pressure and humidity sensors regularly monitor the pressure and humidity inside the chamber to account for the increased humidity from the juices released by the foodstuff being cooked. The humidity control algorithm controls the cooking apparatus and creates the required humidity and pressure inside the cooking chamber 15 by regulating the pump 7 and valve 13. The pump 7 lets more air into the chamber if there is not enough humidity inside the chamber. If the humidity or pressure is too high inside the chamber, the valve 13 releases the pressure.

In a preferred embodiment, the cooking apparatus has a shape of a rectangular box. As shown in FIGS. 1a and 1b, a steam relief area 9 in the form of a gap is provided at the top, bottom and behind the cooking apparatus 10 working as a heat exchanger. Fins 12 are provided on a big plate at the back of the chamber to work as a heat sink, condense the steam and release heat quickly and safely.

The arrangement of the steam relief area 9 allows the released steam to spread in a large area and exhaust at a low temperature. In a preferred embodiment of the invention, an insulation 18 is provided at the top and the bottom of the cooking apparatus 10 to protect the users from burns. This helps the cooking apparatus to release the steam quickly and switch from a first cooking mode to a second cooking mode. In another embodiment of the invention, an additional mechanical safety valve 11 is provided at the back of the cooking chamber. The safety valve 11 decompresses the chamber to reach the normal pressure in the event of pressure reaching above the critical pressure for avoiding any accidents.

In a preferred embodiment, as a foodstuff is placed inside the cooking chamber 15 of the cooking apparatus 10, the pressurized steam is introduced quickly into the cooking chamber through the injector means 16. The pressurized steam is injected into the cooking chamber for a period of time t determined by the method to pressure cook the food in the first stage such that appropriate pressure and temperature inside the chamber are attained very quickly. In a preferred embodiment of the invention, the pressure and steam moisture inside the cooking chamber are maintained for the time period t. The temperature and humidity inside the cooking chamber are controlled by the temperature and humidity sensors provided inside the cooking chamber. The internal temperature of the food can be measured by any suitable temperature measuring device including but not limited to a thermometer or an infrared camera. The method stops the first stage cooking before the internal temperature reaches the critical temperature. The first stage cooking under pressure significantly reduces the overall cooking time. Before transitioning into the second stage of cooking i.e. searing, the pressure inside the cooking chamber should be released. The pump 7 blows the hot air inside the cooking chamber, pushing all the steam out through the mechanical valve 13. The valve 13 allows the steam to release very quickly and safely through the steam relief area provided at the back side of the cooking chamber.

In a preferred embodiment of the invention, the cooking apparatus 10 includes a thermometer 19 to continuously measure the temperature of the foodstuff cooking in the cooking chamber. The thermometer 19 can provide dynamic feedback to adjust temperature and pressure inside the cooking chamber in real-time. In some embodiments of the invention, the thermometer 19 can be adapted to be inserted into the foodstuff to be cooked by the cooking apparatus 10.

In a preferred embodiment of the invention, the cooking apparatus 10 may comprise a searing means for searing the foodstuff located on the ceiling of the cooking apparatus. The searing means may comprise a plurality of heating elements provided inside the cooking chamber 15. As shown in FIG. 1C, the oven ceiling 20 comprises one or more heating elements 21 for cooking the foodstuff placed inside the cooking chamber 15. The heating elements 21 are controlled by a computing device. The computing device may alter or control the power provided to the heating elements using an algorithm. The algorithm may calculate cooking parameters based on the type and quantity of foodstuff placed inside the cooking chamber, the desired level of cooking, and other factors. In a preferred embodiment of the invention, the cooking chamber 15 may comprise a plurality of heating elements 21 for cooking the foodstuff placed inside the cooking chamber. The heating elements 21 can be quartz-halogen tungsten lamps or quartz-arc lamps producing light energy that includes energy in the visible and near visible light spectrum. In some embodiments, any suitable lamps emitting radiant energy in this spectrum may also be used without departing from the scope of the invention. In some embodiments of the invention, reflectors can be placed spaced apart from each of the heating elements 21 on the ceiling of the cooking chamber 15. The reflectors are designed to reflect the radiant energy emitted by the heating elements towards the foodstuff, resulting in efficient and consistent cooking. In some embodiments of the invention, the reflectors may be in the form of a coating on the ceiling. In some embodiments, the reflectors may be a standalone structure, unlike the coating on the ceiling.

In some embodiments of the invention, the ceiling of the cooking chamber 15 may also comprise a camera 22 to capture the image of the foodstuff while cooking. The camera may be connected to the computing device to provide real-time feedback on the cooking process. The feedback may be used by the computing device to adjust the power provided to the heating elements or to stop the cooking process when the desired level of cooking is achieved. A controller may be configured to determine the size and type of the foodstuff based on the images captured by the camera, and selectively activate the appropriate bulbs or lamps based on that determination. For the purpose of explanation, not limitation, the searing means may include a plurality of halogen bulbs, laser or IR lamps for searing the foodstuff at very high temperatures. The number of halogen bulbs, laser or IR lamps to be switched on may be selected based on the size and type of the foodstuff detected by the camera inside the cooking apparatus 10. It should be understood that the use of the camera to detect the size and type of the foodstuff may allow the cooking apparatus to accurately select the appropriate bulbs or lamps for searing, reducing the risk of over or undercooking. The use of halogen bulbs or laser or IR lamps for searing provides high heat output, resulting in a flavorful crust being formed on the surface of the foodstuff.

In some embodiments of the invention, the foodstuff can be dried using cold air after first stage of slow cooking and before the second stage searing. It should be understood that the drying of foodstuff is performed automatically within the oven without removing the foodstuff from the oven. In some embodiments of the invention, the temperature of the oven can be lowered to a predetermined temperature suitable for drying the surface of the foodstuff once slow cook step is complete. An air-circulating device such as a fan within the oven may be activated to circulate the cold air over the surface of the foodstuff to remove the moisture. After a predetermined amount of time, the fan or air-circulating device may be turned off to allow the foodstuff to cool to a predetermined temperature suitable for searing. Once the foodstuff has cooled, searing can be performed at a high temperature for a short period of time to form a flavorful crust on the surface of the foodstuff. The predetermined temperature and time for slow cooking, as well as the predetermined temperature for drying and searing, may be determined based on the type and size of the meat, as well as the desired level of doneness and surface dryness. The method of drying meat using cold air within the oven after the slow cook step may reduce the risk of the meat becoming overcooked or burnt during searing by lowering the surface moisture content.

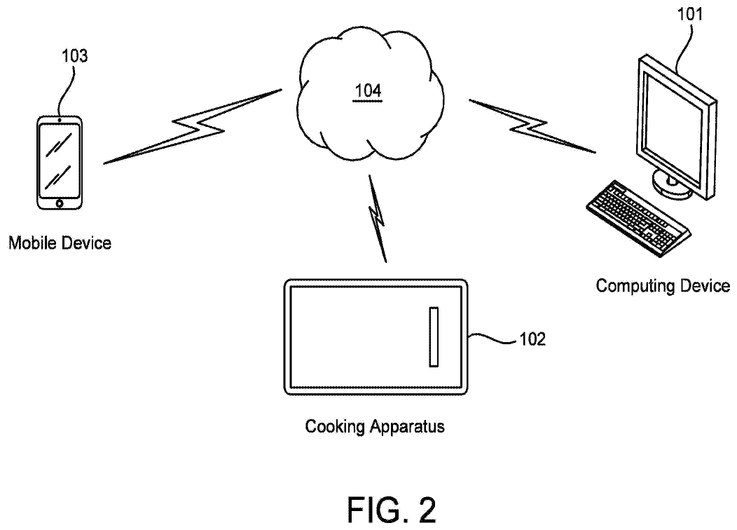

FIG. 2 is a networked system of a cooking apparatus, in accordance with various embodiments. A computing device 101 can store the food profiles of the foodstuff. The computing device 101 can be accessed via a wide area network (WAN) 104, such as the Internet. A cooking apparatus 102 can establish a network connection to the computing device 101. In some embodiments, a mobile device 103 can be connected to the cooking appliance 10 via a local area network or a peer-to-peer connection (e.g., Bluetooth) or an ad-hoc network. In some embodiments, the connection to the cooking apparatus 102 can be established by an access point, a router, the mobile device 103, or other network equipment known to a person of ordinary skilled in the art. It should also be noted that the system shown in FIG. 2, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

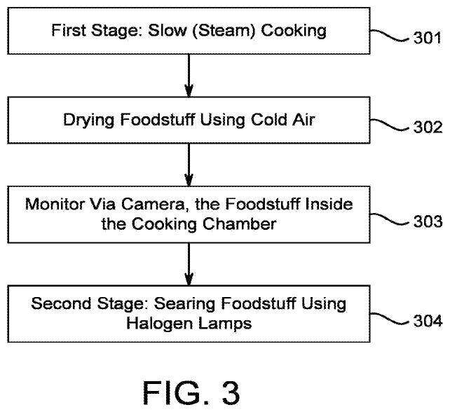

FIG. 3 is a flowchart illustrating a method of cooking a foodstuff in the cooking apparatus 10 in accordance with various embodiments of the invention. An image of the foodstuff is captured by an imaging device such as a camera 22. In some embodiments, the imaging device can be any suitable imaging device, including but not limited to, a mobile phone, tablet computer, a 2D camera, a 3D camera, LIDAR, etc. The size, type and dimensions of the foodstuff placed inside the cooking apparatus 10 can be determined from the images captured by an imaging device 22. At step 301, the foodstuff is cooked using a pressure steam cooking method. Steam cooking and/or pressurized steam cooking can reduce the evaporation of juices from the foodstuff and also allow fast cooking at a lower temperatures due to higher conductivity of the steam. However, steam cooked foodstuff may retain a significant amount of moisture content which may prevent the surface of the foodstuff from reaching the high temperature necessary for searing. This may result in a less crispy and less flavorful crust. Therefore, it is necessary to dry the foodstuff properly before performing the searing to create a caramelized crust on the outside.

At step 302, the foodstuff is dried using cold air after the first stage of steam cooking. The temperature of the oven is lowered to a predetermined temperature suitable for drying the surface of the foodstuff once slow cook step is complete. The surface of the foodstuff is dried by the cold air circulated by an air-circulating device such as a fan inside the cooking chamber. The fan is automatically turned off to allow the foodstuff to cool to a predetermined temperature suitable for searing.

At step 303, the cooking apparatus continuously monitors the foodstuff placed inside the cooking chamber using a camera, preferably provided on the ceiling of the cooking chamber.

At step 304, the cooking apparatus can sear the foodstuff using one or more heating elements provided on the cooking chamber. Once the foodstuff is dried and ready for the searing, heating elements 21 provided on the ceiling of the cooking chamber can be activated. In some embodiments, the heating elements may be selected from a group comprising, tungsten halogen, infrared, and laser. An algorithm controls the power provided to the heating elements based on feedback received from the camera. The power provided to the heating elements can be controlled based on the type and quantity of foodstuff placed inside the cooking chamber.

In an embodiment of the invention, the rate of change of the internal temperature of the foodstuff can be used to predict the change in parameters of the first cook period. The rate of change of the internal temperature of the foodstuff can be calculated from the reading received from the thermometer. The method can estimate an updated time for cooking the foodstuff in the first stage based on the rate of change of the internal temperature of the foodstuff during the first cook period. The method can further predict the amount of time to be reduced for cooking the foodstuff in the first stage based on the rate of increase in the internal temperature of the foodstuff while cooking. In some embodiments of the invention, at least one of the cooking periods should be changed such that the critical temperature is not reached before the cooking is complete. In some embodiments of the invention, the cooking mode of the cooking apparatus is changed from the first cooking mode to the second cooking mode such that the internal temperature of the foodstuff reaches the critical temperature only after the cooking process is complete. The changing of the cooking modes is performed seamlessly such that the cooking apparatus provides perfectly cooked food after the completion of the cooking process. In some embodiments, the time of the first (slow) cooking period is reduced based on the rate of change of the internal temperature of the foodstuff, the time of the searing in the second cooking period and the parameters of the searing in the second cooking period. The initial temperature of the foodstuff can be determined using various methods, including but not limited to, an infrared sensor placed inside or outside the cooking chamber of the cooking apparatus, a thermometer placed inside or outside the cooking chamber of the cooking apparatus, input by a user using an appropriate input means etc. The camera and sensors inside or outside the cooking chamber can identify the type of foodstuff, size of the foodstuff and initial temperature of the foodstuff. The method calculates the total cooking period such that internal temperature reaches the critical temperature based on the rate of change of the internal temperature of the foodstuff, size of the foodstuff, and initial temperature of the foodstuff.

In an alternate embodiment, a camera inside the cooking apparatus 10 can identify the foodstuff like beef, chicken, fish etc. placed inside the cooking chamber 15. The cooking apparatus can download the properties of the foodstuff from a database available at the computing device, user mobile device etc. Based on the properties of the foodstuff, the cooking apparatus determines the first portion of the time of cook and reduce that time such that when the sear happens in the next stage of cooking, the critical temperature is achieved but not exceeded and foodstuff is not overcooked.

In some embodiments of the invention, a user can change the amount of sear through an application installed on their mobile device. The user can also change the temperature and duration of the sear to the desired crisp level. In other embodiments, the user can select the predefined settings from the application. Based on user selection, the method can change (increase or decrease) the amount of time for steam cooking and searing.

In the preferred embodiments of the invention, the first stage cooking method can be pressure cooking the foodstuff at a low temperature and the second stage cooking method can be searing the foodstuff at a high temperature. Cooking the foodstuff in the first stage at a low temperature for a longer period of time may overheat the cooking apparatus which may eventually overcook the food while searing in the second stage. To cool down the cooking apparatus after the first stage of cooking, air, preferably cold air, can be introduced in the cooking apparatus between the first stage cooking and the second stage cooking. It should be understood that the transition of the cooking apparatus from the first stage low temperature cooking to the second stage high temperature cooking may take some time. To stop cooking the foodstuff for this period of time, in one embodiment, non-moving cold air can be introduced into the cooking chamber of the cooking apparatus, forming an envelope around the foodstuff. In another embodiment, cold air can be continuously injected into the cooking chamber while the cooking apparatus heats up for the second stage of cooking. When the cooking apparatus reaches the required temperature for searing, the cold air injection can be stopped, and one or more fans of the cooking apparatus can be started causing the air to become turbulent and perform searing of the foodstuff inside the cooking chamber.

In some embodiments of the invention, for reducing the overall cooking time, the cooking chamber can be heated and prepared for the second stage of cooking while the cooking apparatus is being operated in the first stage of cooking. In an example embodiment, cold or room temperature air can be injected into the cooking chamber without circulation while the foodstuff is cooking in the first stage. In another example embodiment, cold air can be continuously pumped into the cooking chamber while the foodstuff is cooking in the first stage. Once the cooking chamber is hot enough for the high temperature searing, the cold air can be stopped from being introduced into the cooking chamber. Further, one or more fans can be started causing the air to become turbulent and perform searing of the foodstuff inside the cooking chamber.

According to another embodiment of the invention, the overall cooking time can also be reduced by using an inner metal vessel, for example made from thin steel, inside the main cooking chamber 15. The cooking chamber 15 of the cooking apparatus can be designed in a way that the inner metal vessel can be provided inside the cooking chamber 15. A layer of insulation can be filled between the inner metal vessel and the cooking chamber. In a preferred embodiment of the invention, the insulation between the cooking chamber 15 and the inner metal vessel can be made with a strong material that can withstand the pressure of the steam inside the cooking apparatus. Since the inner metal vessel is made with very thin steel, it heats up quickly and gets prepared for second stage searing. One of the primary advantages of this embodiment of the invention is that the preheating of the oven can be avoided. Further, the inner metal vessel heating up quickly reduces the chances of overcooking the foodstuff at the second stage searing. In an example embodiment, the inner metal vessel can be made with a quarter mm thick steel and outer or main cooking chamber can be made with 3 mm thick steel. In the preferred embodiments, the outer chamber provides structural elements to the cooking apparatus so that it can hold the pressure or force of the steam inside the oven against the inner vessel. Therefore, the outer chamber provides the structure to the cooking apparatus and inner vessel provides quick heating capabilities.

According to another embodiment of the invention, the design of the cooking apparatus can also be improved to prevent smoke generation resulting from fats and oils during the cooking process. In some embodiments, the cooking apparatus may incorporate a specialized tray with a lid strategically positioned beneath the food to effectively insulate and contain the oils and grease, thereby preventing them from reaching their smoke point. When the oven temperature surpasses 300 degrees, the fats from the cooking foodstuff such as meat may liquefy and drip onto the tray leading to smoke and sizzling inside the oven.

In a preferred embodiment, the tray may be comprised of two layers—an upper first layer and a recessed second layer. The foodstuff like meat can be placed on a grill situated above the tray. In some cases, the first layer remains relatively cool due to the hot air circulating inside the cooking apparatus not reaching below the grill level. As a result, the tray does not become excessively hot, ensuring that the cooking apparatus remains free from smoke. In another embodiment, the upper first layer (lid) of the tray can be equipped with appropriately sized holes that allow the liquefied oil to pass through under the influence of gravity. The oil can be collected in the lower second tray. It should be understood that these holes are designed to impede the entry of circulating air due to pressure differentials. Therefore, air predominantly follows the path of least resistance, bypassing the holes in the upper first layer when an unobstructed path back to the oven's fan exists.

In an alternate embodiment, the tray can be designed with a double-walled structure that is connected to the outer surface of the cooking apparatus. This arrangement enables the tray to draw in outside air through an inlet and circulate it through the inner cavity of the double-walled tray using a small fan. The continuous air circulation within the tray ensures that the upper portion of the tray remains cooler than the rest of the cooking apparatus, thereby preventing the oils from reaching their smoke point and effectively reducing smoke generation. The enhanced cooking apparatus tray design can ensure efficient insulation and containment of oils, thus preventing the oils from reaching their smoke point and minimizing smoke production within the cooking apparatus.

In an alternate embodiment of the invention, the cooking apparatus can also have a pot to contain any suitable flavoring spices such as clove, basil, etc. The steam generated by the steam generating means can travel through the flavoring pot. In another embodiment, the water for generating the steam can travel through the flavoring pot to generate the flavored steam. When flavored steam is injected into the cooking chamber, the steam circulates around the foodstuff. With this method of steam marinating, foodstuff can be infused with a particular flavor of user choice.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A cooking method, comprising:
cooking a food item at a first cooking temperature in a cooking chamber for a first cooking period; and
searing the food item at a second cooking temperature in the cooking chamber for a second searing period,
wherein the first cooking temperature, and/or the second cooking temperature, and/or the first cooking period, and/or the second searing period are determined at least in part based on an imaging device that determines identification of the food item by using an artificial intelligence (AI) method and/or that determines at least one 3D parameter of the food item.

2. The method of claim 1, wherein the cooking chamber is composed of an outer chamber, a thinner inner metal vessel provided inside the outer chamber, and an insulation filled between the inner metal vessel and the outer chamber, thereby facilitating and accelerating an increase in temperature from the first cooking temperature to the second cooking temperature.

3. The method of claim 1, wherein the cooking the food item at a first cooking temperature in a cooking chamber comprises injecting steam into the cooking chamber, and wherein the method further comprises release the steam from the cooking chamber after the cooking the food item at a first cooking temperature in a cooking chamber.

4. The method of claim 1, wherein the cooking the food item at the first cooking temperature in the cooking chamber comprises injecting steam and/or air into the cooking chamber.

5. The method of claim 1, wherein the cooking the food item at the first cooking temperature in the cooking chamber comprises injecting steam and/or air into the cooking chamber, and wherein the steam or air is pressurized.

6. The method of claim 1, wherein the cooking the food item at the first cooking temperature in the cooking chamber comprises injecting steam and/or air into the cooking chamber and cooking the food item with heating element.

7. The method of claim 1, further comprises releasing pressure from the cooking chamber through a valve of the cooking chamber, after the cooking the food item at the first cooking temperature in the cooking chamber.

8. The method of claim 1, wherein the cooking the food item at the first cooking temperature in the cooking chamber comprises injecting steam and/or air into the cooking chamber, and
wherein the method further comprises releasing pressure from the cooking chamber through a valve of the cooking chamber, after the cooking the food item at the first cooking temperature in the cooking chamber.

9. The method of claim 1, wherein the cooking the food item at the first cooking temperature in the cooking chamber comprises injecting steam and/or air into the cooking chamber, and
wherein the method further comprises:
releasing pressure from the cooking chamber through a valve of the cooking chamber, after the cooking the food item in the cooking chamber at the first cooking temperature, and
expanding and mixing the steam and/or air with outside air in an exit chamber, before the releasing pressure from the cooking chamber.

10. The method of claim 1, wherein the cooking the food item at the first cooking temperature in the cooking chamber comprises injecting steam and air into the cooking chamber, and wherein the steam and air are mixed prior to being injected into the cooking chamber.

11. The method of claim 1, wherein the cooking the food item at the first cooking temperature in the cooking chamber comprises injecting steam and air into the cooking chamber, and wherein prior to being injected into the cooking chamber, with a computer-controlled mixer valve, the steam and air are mixed to a desired amount to provide the first cooking temperature.

12. The method of claim 1, further comprising rendering the cooking chamber to a third temperature, between the cooking the food item and the searing the food item.

13. The method of claim 1, further comprising rendering the cooking chamber to a third temperature, between the cooking the food item and the searing the food item, wherein the third temperature is lower than the first cooking temperature, and wherein the rendering the cooking chamber to the third temperature is to reduce a moisture and/or a temperature of the surface of the food item.

14. The method of claim 1, further comprising rendering the cooking chamber to a third temperature, between the cooking the food item and the searing the food item, wherein the rendering the cooking chamber to a third temperature comprises pumping cold air into the cooking chamber and removing previous air from the cooking chamber.

15. The method of claim 1, further comprising rendering the cooking chamber to a third temperature, between the cooking the food item and the searing the food item, wherein the rendering the cooking chamber to a third temperature comprises pumping cold air into the cooking chamber and removing previous air from the cooking chamber, and wherein the cold air is circulated in the cooking chamber to facilitate reduction of temperature of the food item on its surface.

16. The method of claim 1, wherein the searing the food item comprises searing the food item with a searing element such as heating lamps.

17. The method of claim 1, wherein the searing the food item comprises searing the food item with a searing element, and wherein prior to the searing the food item, the searing element is preheated without air being circulated in the cooking chamber.

18. The method of claim 1, wherein the cooking the food item at the first cooking temperature in the cooking chamber comprises injecting steam and/or air into the cooking chamber, and wherein the method further comprises:
sensing pressure in the cooking chamber; and
opening a valve of the cooking chamber if the pressure in the cooking chamber increases above a desired pressure, and/or injecting periodically the steam and/or air into the cooking chamber if the pressure in the cooking chamber falls below the desired pressure, so as to have the pressure in the cooking chamber to the desired pressure.

19. The method of claim 1, further comprising:
releasing pressure from the cooking chamber through a safety valve if the pressure in the cooking chamber increases above a critical pressure.

20. The method of claim 1, wherein the first cooking period and/or the second cooking period depend on initial parameters of the food item when it was first inserted into the cooking chamber.

21. The method of claim 1, further comprising rendering the cooking chamber to a third temperature for a third period, between the cooking the food item and the searing the food item, wherein the third period depends on initial parameters of the food item when it was first inserted into the cooking chamber.

22. The method of claim 1, wherein the first cooking period and/or the second cooking period depend on initial parameters of the food item when it was first inserted into the cooking chamber, and wherein the initial parameters comprise 3D shape and/or initial temperature of the food item.

23. The method of claim 1, wherein the first cooking period and/or the second cooking period depend on initial parameters of the food item when it was first inserted into the cooking chamber, and wherein the initial parameters comprise 3D shape and/or initial temperature of the food item, and wherein the initial temperature of the food item comprises an initial temperature of the food item's surface.

24. The method of claim 1, wherein the first cooking period and/or the second cooking period depend on initial parameters of the food item when it was first inserted into the cooking chamber, and the identification of the food item and/or user preference of doneness level of the food item.

25. The method of claim 1, further comprising rendering the cooking chamber to a third temperature for a third period, between the cooking the food item and the searing the food item, wherein the third period depends on initial parameters of the food item when it was first inserted into the cooking chamber, and the identification of the food item and/or user preference of doneness level of the food item.

26. The method of claim 1, wherein the first cooking period and/or the second cooking period depend on initial parameters of the food item when it was first inserted into the cooking chamber, and the identification of the food item and/or user preference of doneness level of the food item, and wherein the identification of the food item is based on the imaging device and/or the AI method and/or a third party AI service.

27. The method of claim 1, wherein during the second cooking period, air is circulated in the cooking chamber at a different speed than during the first cooking period.

28. The method of claim 1, wherein cooking parameter(s) of the cooking method is adjustable by user, and wherein user's adjustment of the cooking parameter(s) of the cooking method during an instance of the cooking method is taken into account for a future instance of the cooking method.

29. The method of claim 1, wherein the cooking chamber is composed of an outer chamber, a thinner inner metal vessel provided inside the outer chamber, and an insulation filled between the inner metal vessel and the outer chamber, and wherein the inner metal vessel is made from steel, and wherein the insulation is made with a material that can withstand the pressure inside the inner metal vessel.
